(19) United States
(12) Patent Application Publication
(10) Pub. No.: US 2010/0289980 A1
(43) Pub. Date: Nov. 18, 2010

(54) Double-sided adhesive tape for liquid crystal display systems

(76) Inventors: Marc Husemann, Hamburg (DE); Reinhard Storbeck, Hamburg (DE)

Correspondence Address: Briscoe, Kurt G.;Norris McLaughlin & Marcus, PA, 875 Third Avenue, 8th Floor, New York, NY, 10022, US

(21) Appl. No.: 12/746,983

(22) PCT Filed: Dec. 12, 2008
(86) PCT No.: PCT/EP08/67408

§ 371 Date: Jul. 14, 2010

(30) Foreign Application Priority Data
Dec. 20, 2007 (DE) 10 2007 062 447.8

(51) Int. Cl. G02F 1/1333; C09J 7/00; G02B 1/00; B32B 7/00

(52) U.S. Cl. 349/58; 428/354; 428/141; 156/313

(57) ABSTRACT

The invention relates to an adhesive surface element for producing liquid crystal displays, wherein the surface element comprises the following sequence of layers: first adhesive layer (11), carrier (12), metal layer (13), absorbance layer (14), second adhesive layer (5), and whereby the absorbance layer (14) is a layer having carbon black that is not adhesive at room temperature and/or that is a primer, and the first adhesive layer (11) is colored translucent white over the entire thickness thereof: The invention further relates to the use of such a surface element for producing and/or adhering liquid crystal display systems, wherein the second adhesive mass (15) is adhered to the surface of a liquid crystal display element, and a liquid crystal display system having a liquid crystal display element (1), a protective element, and a frame element, wherein at least two of said elements are connected by means of the above surface element.

This application is a 371 of PCT/EP2008/067408, filed Dec. 12, 2008, which claims priority of German Application No. 10 2007 062 447.8, filed Dec. 20, 2007.

The invention relates to a pressure-sensitively adhesive sheetlike element for producing liquid-crystal display systems, having the following sequence of layers: first adhesive layer, carrier, metallization layer, blacking layer, second adhesive layer, the blacking layer being a layer having a black color varnish and/or primer which is not pressure-sensitively adhesive at room temperature, and also to a liquid-crystal display system.

Nowadays, for the positionally accurate adhesive bonding of individual components in electronic devices, pressure-sensitive adhesive tapes are used. This is likewise the case for liquid-crystal display systems, in which different components are bonded to one another: for example, a liquid-crystal display unit (called an LCD panel) to an antisplinter plate and to a housing.

In contrast to self-illuminating display systems such as, for instance, those based on cathode-ray tubes (CRT) or light-emitting diodes (LED), liquid-crystal display units require separate illumination. In the simplest case, a liquid-crystal display system is operated in reflection, and so there is no need for the liquid-crystal display system to have its own lighting unit; instead, it merely reflects light incident from the outside. Systems of this kind, however, can be used only in light environments. Liquid-crystal display systems which can be used universally therefore need their own lighting unit, referred to as a backlight. A lighting unit of this kind illuminates the liquid-crystal display unit from the back face, in transmitted-light operation.

As the light source of the lighting unit, typical liquid-crystal display systems often use light-emitting diode systems featuring a white emission characteristic. In order to produce display systems whose overall depth is low, the light-emitting diodes are not arranged immediately behind the liquid-crystal display unit, but instead are offset laterally with respect to the display unit, in a plane behind the display unit. In an arrangement of this kind, the emitted light is guided via an optical waveguide of the lighting unit to the liquid-crystal display unit.

In the interest of maximum display contrast it must be ensured that the light is able to reach the viewer exclusively through the display area of the liquid-crystal display unit. Consequently, the outer edge of the display area is typically masked by a framelike, light-impermeable bordering element, which prevents the light emitted from the light-emitting diodes from being able to reach the viewer, past the display unit, and being perceived by said viewer as disruptive bright light spots.

In addition to the light-impermeable design on the bottom face of the bordering element, its top face ought to exhibit minimal light reflection. In this way, disruptive light reflections at the top face of the bordering element, which may come about as a result, for instance, of external light sources, are prevented, or in the case of unwanted reflection of the light passing through the display area at the inside of the housing, which is particularly disruptive for viewing angles which deviate highly from the perpendicular.

On practical grounds it is rational to integrate a bordering element of this kind in the form of a colored region into a double-sided adhesive tape. With the adhesive tape, the top face of the liquid-crystal display unit is joined, for instance, to the lighting unit, to a protective plate or to the housing of the electronic device. Through the use of a combined adhesive element and bordering element, the overall depth of the installed display system can be reduced.

In order to obtain maximum absorption for light from the lighting unit and minimum reflection for ambient light, it has proven advantageous in respect of the bordering element, among other things, to use a black coloring, more particularly a matt-black coloring. For the adhesive bonding of liquid-crystal display units, a host of different realizations are known for double-sided adhesive tapes of this kind with blacked zones.

Thus, for example, the electronics industry uses preferably double-sided pressure-sensitive adhesive tapes with polyester film carriers such as, for instance, those made of polyethylene terephthalate (PET), since pressure-sensitive adhesive tapes with this kind of construction can be diecut particularly well. Such polyester carriers are colored with color particles such as, for instance, carbon black or other black color pigments. The carrier of such a pressure-sensitive adhesive tape, however, cannot be designed to be arbitrarily thick, since that would deleteriously reduce the flexibility of the adhesive tapes. There is a limit, therefore, on the maximum amount of color particles that can be incorporated overall into the carrier layer, since larger quantities of color particles would necessitate thicker carrier films, which in turn would impair the flexibility of the adhesive tape. Consequently, pressure-sensitive adhesive tapes of this kind do not absorb the light completely, but instead transmit a certain portion of the light, and this is particularly disruptive in the case of intense light sources, in other words with light sources having a luminous intensity of more than 600 Cd.

Higher light absorption can be achieved with pressure-sensitive adhesive tape systems which comprise a two-ply carrier (below, the abbreviated terms absorption and transmission are used to describe the absorption and transmission of light from the visible region of the spectrum). Two-ply carriers are typically produced by coextrusion, in which the carrier material itself, for achieving the desired mechanical stability, and the blacked material, for achieving the optical absorption, are extruded simultaneously to produce the two-ply carrier. With coextrusion of this kind, however, it is necessary to employ additives to prevent sticking of the one extruded material to the other (antiblocking agents). On account of their adhesion-reducing effect, however, these additives may result in holes, known as pinholes, in the colored lamina. These pinholes act as optical defect sites, since light is able to pass through the holes, and so these systems as well do not offer full-area absorption.

Another problem affecting coextruded carriers of this kind is that the two plies are first shaped separately in the die head of the extruder and are joined only subsequently. As a result, each layer must have a certain inherent thickness which ensures the desired mechanical stability of the adhesive tape and fully absorbs the light. Consequently, only relatively thick dual carriers can be produced by means of coextrusion, and so, ultimately, the flexibility of the adhesive tape is low and hence the tape is able to conform only poorly to the shape of the surfaces to be bonded to one another.

Another disadvantage of the dual carrier is that each of the adhesives used differs in the extent of its adhesion to the different top faces of the coextruded carrier, and so the double-sided adhesive tapes generally possess an unwanted weak point of lower mechanical load-bearing capacity, namely the joining area between the carrier and one adhesive, since in the case of the latter the anchoring of the adhesive on the carrier is poorer.

In a further structure of a pressure-sensitive adhesive tape having complete absorption capacity for light incident from the outside, one side face or both side faces of the carrier bear or bears a black color varnish layer. These systems combine the advantages and disadvantages of the two systems described above: on the one hand, it is easy for pinholes to occur in the blacking, these pinholes being produced as a result of the use of antiblocking agents during the extrusion of the films. On the other hand, the absorption of light is generally not complete, since only relatively thin varnish laminae can be applied, so as not to cause deleterious alteration overall to the mechanical properties of the adhesive tape. With this method as well, therefore, it is not possible to ensure complete, full-area absorption of light.

An additional factor, furthermore, is that it is necessary to take account of the general technical development of liquid-crystal displays. Hence there is increasingly a demand for larger display areas with higher resolutions, and the display systems themselves are to be lighter in weight and flatter. This leads to drastic alterations in the technical design of such display systems. Thus it is necessary for the distance between the light source and the liquid-crystal display unit to become smaller. As a result, however, there is likewise more light emitted into the shaded area. This light pass through the shading and out of the device. In order to prevent this, adhesive tapes with relatively high absorption are necessary. In view of the greater dimensions of the display systems, moreover, these tapes must possess a relatively high mechanical stability.

In order to minimize the light losses overall and hence to increase the display contrast, it is rational, moreover, for the side of the adhesive tape that faces the lighting unit to be of a highly reflective nature. With the highly reflective coatings as well, the problem arises that the carrier lamina antiblocking agents that are typically employed cause holes in the highly reflective coating, resulting in inhomogeneities in the reflected image.

In current display systems there are two different embodiments of a highly reflecting coating that are encountered: The side face of the adhesive tape may have a white coloring or may be metallically reflecting. Both systems have advantages and disadvantages.

Where a white coloring is used, there is diffuse scattering of the irradiated light within the white color lamina. The advantage of a white color lamina of this kind is that it is easy to produce, technically speaking, in an adhesive tape. For instance, the white color lamina may be an additional white varnish lamina on one side face of the carrier. The white color lamina, however, may also be represented by the adhesive coating itself, if the latter is colored white through addition of appropriate color particles.

Where the color lamina comprises exclusively white color pigments, there are no absorption processes, and the intensity of the light scattered by the white lamina is the same as that of the irradiated light. However, since the extent of scattering is dependent on the wavelength of the scattered light, the components in the white light that possess a shorter wavelength (blue light, for instance) undergo greater scattering than the components with longer wavelengths (red light, for instance). This effect, known as Rayleigh scattering, results in a weak yellow tinge to the scattered white light at certain viewing angles, since blue components of the light are more highly scattered. As a result, there are local differences in the color intensity of the reflected light, and hence also color inhomogeneities in the reflected image.

A metallically reflecting lamina offers the advantage of direct reflection of the irradiated light, with no viewing-angle-dependent dispersion of the scattered light. However, systems of this kind are susceptible to creases, which may easily come about in the course of storage, transport, processing, positioning or adhesive bonding of such adhesive tapes, and result in an inhomogeneous distribution of lightness in the reflected image.

An example of a liquid-crystal display system with a double-sided adhesive tape in which one side is highly reflecting and the other side is light-impermeable is shown diagrammatically in FIG. 1.

The light beams 5 from a light source 4 are deflected in an optical waveguide 7, pass through the liquid-crystal display unit 1, and eventually pass from the housing 9 of the electronic device to the viewer. In order to increase the luminous yield of the light source 4, the back inside wall of the housing 9 has a reflective foil 8 affixed to it by means of an adhesive coating 6.

The optical waveguide 7 of the lighting unit is joined via a double-sided adhesive tape to the liquid-crystal display unit 1. The double-sided adhesive tape is composed of a black-colored, light-impermeable carrier film 10, whose bottom face bears a metallic reflecting layer 2 and which is bonded via the two adhesive laminae 3 to the top face of the optical waveguide 7 and the bottom face of the liquid-crystal display unit 1.

The double-sided adhesive tape takes the form of a framelike diecut which, as a result of the black coloration and the metallic implementation, subdivides the total area of the liquid-crystal display unit 1 into a visible area B and a shaded area A and hence acts as a bordering element.

Several embodiments of colored and/or metallized adhesive tapes are described in the literature for the adhesive bonding of display devices. Thus JP 2002-350612 discloses double-sided reflecting adhesive tapes for liquid-crystal display systems. The adhesive tapes comprise carriers coated on one or both sides with a metallic film, it being possible for the carriers to be colored as well. Adhesive tapes of that kind, however, have exclusively reflecting properties, and so a side face which absorbs the light completely, over the full area, but at the same time is non-reflecting, is not produced.

WO 2006/058910 and WO 2006/058911 disclose the use of double-sided adhesive tapes which are composed of a carrier which is covered on one side by a metallic lamina on which a black-colored layer of pressure-sensitive adhesive is arranged, with a transparent layer of pressure-sensitive adhesive on said black layer of pressure-sensitive adhesive. On the side of the carrier that is not metallically coated, the adhesive tapes are furnished with a further layer of pressure-sensitive adhesive. In the system described in WO 2006/058910, the adhesive is white, whereas, in the system described in WO 2006/058911, the adhesive is transparent and the carrier is white.

Furthermore, WO 2006/133745 discloses the use of a double-sided adhesive tape which is composed of a transparent carrier covered on one side with a metallic lamina, on which there is a black-colored layer of pressure-sensitive adhesive arranged, which in turn bears a transparent layer of pressure-sensitive adhesive. On the side of the carrier that is not metallically coated, the adhesive tape has a white layer of pressure-sensitive adhesive, again with a transparent layer of pressure-sensitive adhesive thereon.

In addition to the problems described above with regard to the distribution of intensity, adhesive tapes in which the highly reflecting layer is disposed downstream of a transparent adhesive coating in the optical path exhibit light losses owing to the parallel-reflected light.

Parallel-reflected light comes about when light from outside enters the adhesive flatly, in other words at a low incident angle which deviates greatly from the perpendicular. Where the adhesive—as is normally customary—has a lower refractive index than the optical waveguide from which the light emerges, transition to the adhesive is accompanied by refraction of the light away from the perpendicular, and so the light enters the adhesive coating at an angle which is lower then the angle at which it has left the optical waveguide. Consequently, the light reflected at a metallically reflecting layer also strikes the boundary surface between the adhesive and the optical waveguide at a smaller angle than was the case on entry into the adhesive.

Since the angle of incidence was small in any case, the further reduction in the angle may result in it becoming smaller than the limiting angle of total reflection, with the consequence that the light is reflected at the boundary surface. The reflected light is therefore unable to leave the adhesive coating, and is reflected between the two boundary faces as parallel-reflected light, parallel to the principal extent of the layer. Since the parallel-reflected light is no longer able to leave the sheetlike element as a result of the boundary layer between adhesive and optical waveguide, but instead is able to depart only at the end faces of the adhesive coating, the overall result of this is to reduce the luminous yield of the display device.

It was an object of the present invention, therefore, to provide a double-sidedly bondable sheetlike element having one non-reflecting side face that at the same time provides full-area absorption of light, and one highly reflecting side face, this element eliminating the disadvantages outlined above, and, more particularly, exhibiting a homogeneous intensity distribution of the reflected light in combination with an intensity that is high overall, without any adverse overall effect on the processability and bondability of the sheetlike element.

This object is achieved in accordance with the invention by means of a sheetlike element of the type specified at the outset, in which the first adhesive layer has, over its entire thickness, white pigments at a mass fraction from a range of at least 2% by weight and not more than 10% by weight, preferably of at least 4% by weight and not more than 8% by weight. An adhesive of this kind is neither fully transparent nor fully white, but instead is of weakly translucent-white design.

Through the use of a combination of both reflection systems, a metallically reflecting metallization layer and a translucent-white adhesive layer, the advantages of the one reflection system are used to compensate the disadvantages of the other reflection system, and so this synergistically mutual effect produces a highly reflecting coating which exhibits a homogeneous intensity distribution that is independent of viewing angle.

The use of a white translucent adhesive layer offers the advantage over a white adhesive layer (that is, an adhesive layer which, owing to the white color particles it contains, transmits less than 1% of the irradiated light for the specific thickness of the layer), that wavelength-dependent scattering processes are less frequent and therefore that, even at low viewing angles, the incidence of color distortions (particularly a yellow tinge) as a result of scattering processes is visibly reduced.

Furthermore, the use of a white translucent adhesive over a transparent adhesive offers the advantage that the irradiated light penetrates the adhesive, is reflected wavelength-independently at the metallization layer, and emerges again from the sheetlike element. This light undergoes little scattering in the slightly hazy adhesive layer, and so this compensates local inhomogeneities in the intensity of illumination (diffusor arrangement), of the kind that may occur with creases in the metallization layer.

A further factor is that the combination of both reflection systems increases the luminous yield that is achievable overall, since the fraction of the parallel-reflected light as a proportion of the light reflected overall is reduced. As a result of the weakly scattering design of the adhesive, some of the parallel-reflected light in the sheetlike element of the invention is diverted diffusely at the scattering centers, and therefore strikes the boundary surface at angles (inter alia) that are greater than the angle of total reflection, and is therefore able to leave the adhesive, resulting overall in an increase in luminous intensity (luminous yield).

The inventive design of the sheetlike element offers the advantage, moreover, that a translucent white adhesive of this kind can also be illuminated homogeneously by light having wavelengths from the spectral range of ultraviolet light (UV). As a result of the fact that the translucent white adhesive transmits at least some of the irradiated UV light, it is possible, when manufacturing the sheetlike elements, to increase the viscosity of the adhesive, following its application to the carrier, in a UV postcrosslinking operation, which in the case of a white adhesive in particular is not possible over the entire volume of the adhesive owing to the particularly high degree of scattering for shortwave UV light.

However, advantageous effects emerge not solely from the combination of two functional laminae at the highly reflecting side face, but likewise from the combination of two functional laminae in relation to the strongly absorbing system: The use of a combination of a blacking layer and of a metallization layer ensures full-areally complete absorption on the part of the sheetlike element. The optical defects are distributed statistically in a low areal density within the sheetlike element. Light which passes through one of the layers if that layer has an optical defect is therefore not able as a whole to pass through the sheetlike element, since the probability that the other layer will likewise have a hole at the same location where one layer possesses a hole is small.

The specific arrangement ensures, furthermore, that the greatest part of the light is reflected on the side of the sheetlike element at which very high luminous intensities occur, and at most a very small fraction is absorbed, with the consequence that significant heating of the blacking layer as a result of light absorption is prevented; such heating might otherwise result in thermal deterioration of the adhesive bond, as for instance to stresses between the individual plies of the sheetlike element as a result of differences in coefficients of thermal expansion, or softening or thermal decomposition of the blacking layer.

The use of a blacking layer permits a uniform external appearance and at the same time makes it possible to reduce the reflected ambient light. Additionally—since a blacking layer and not, for instance, a black-colored adhesive layer is used—there is prevention of significant heating of the adhesive as a result of absorption in situations of high ambient light intensities, and of loss of cohesion owing to temperature-induced decrease in the viscosity of the adhesive, which would adversely affect the strength of the adhesive bond overall.

It is advantageous if the sheetlike element comprises as a blacking layer a cured polymer matrix which comprises carbon-black particles and/or graphite particles. Using a cured polymer matrix produces a highly mechanically stable sheetlike element whose blacking layer exhibits high light absorption. Through the polymer matrix, in particular, a load-bearing connection is produced between the blacking layer and the carrier, and at the same time between the blacking layer and the adhesive as well. Through the specific choice of particles composed at least substantially of carbon as color particles used for blacking, there are further advantages. For instance, these particles not only are nontoxic and highly stable to many corrosive processes that may occur during the production and use of such sheetlike elements (as a result, for instance, of exposure to solvents, light, moisture, air, and the like), but they may also be compatible, furthermore, with the polymer matrix, with the consequence that the blacking layer itself has a high internal stability as well.

It is particularly advantageous in this context if the blacking layer has a transmittance in the wavelength range from 300 nm to 800 nm of less than 0.5%, preferably of less than 0.1%, more preferably of less than 0.01%. As a result of this, a blacking layer with particularly high light absorption is obtained. When carbon-black particles and/or graphite particles are used in a polymer matrix as a blacking layer, moreover, the color particles may be present in the polymer matrix at a mass fraction of more than 20% by weight. In this way, independently of particle size and extinction coefficient of the particular carbon black and/or graphite used, a sufficiently high light absorption is ensured.

The carrier may advantageously be a PET film. This material is particularly suitable for display devices on account of its outstanding processability and stability and also its high optical transparency (in the case of adhesive bonds within the visible range, for example).

Advantageously, moreover, the carrier top face in contact with the metallization layer has an antiblocking agent content of less than 4000 ppm, preferably of less than 500 ppm. In this way, the incidence of any optical defects (pinholes) can be further reduced. Particularly high-grade sheetlike elements are obtained if the PET film top face in contact with the metallization layer has texturing with elevations of not more than 400 nm in height. As a result of this particular design of the top face of the carrier, there is no need at all for antiblocking agent additives on this side face of the carrier, since the three-dimensional texturing is enough to effectively prevent blocking of the material.

Furthermore, the metallization layer may comprise a metallic-varnish layer and/or a metallic layer of aluminum or silver. Through the metallic-varnish layer or metallic layer embodiment it is possible to obtain a highly reflecting coating which can be produced by means of conventional process means. Particularly suitable material for this metallization layer comprises silver and aluminum, since both materials are highly stable and, furthermore, provide high reflection of light from the visible region of the light spectrum, without any significant wavelength dependency of the absorption in this wavelength range. Aluminum, for example, shows reflection of more than 90%, while silver, at more than 99.5%, exhibits in fact the greatest light reflection of all metals.

Another object of the present invention was to provide a liquid-crystal display system comprising a liquid-crystal display element, a protective element, and a frame element, said system possessing a particularly uniform and luminously intense display. This can be realised through the use of the sheetlike element of the invention for adhesively bonding at least two of these elements.

Finally, the present invention should allow inexpensive production of a liquid-crystal display system with high contrast. This becomes possible through use of the sheetlike element of the invention when the second adhesive is bonded to the surface of the liquid-crystal display element. Accordingly, the second adhesive is bonded to a further element of the liquid-crystal display system, as for example to a protective element, a frame element or a housing element.

The invention accordingly further provides a pressure-sensitively adhesive sheetlike element. Sheetlike elements for the purposes of this specification include all customary and suitable structures having a substantially two-dimensional extent. They allow adhesive bonding and may take various forms, particularly flexible forms, as an adhesive sheet, adhesive tape, adhesive label or shaped diecut. Pressure-sensitively adhesive sheetlike elements are sheetlike elements which can be bonded under just a slight applied pressure and can be detached again without residue from the substrate. For this purpose, the sheetlike element is furnished on both sides with adhesives, and the adhesives may be identical or different.

In the present case the sheetlike element has a carrier. However, the measures according to the invention may also be transposed to sheetlike elements which have no carrier, without deviating from the inventive concept. Carrier-free sheetlike elements of such kind are therefore considered to be equivalent in an inventive respect.

The sheetlike element of the invention is used for producing liquid-crystal display systems, more particularly for adhesively bonding liquid-crystal display elements, protective elements, and frame elements.

A liquid-crystal display system is a functional device which serves to display information and for that purpose has a liquid-crystal display element as its display module. This display system may be a minor part of a device or may be designed as a self-standing device.

A liquid-crystal display element is a functional unit which comprises a display area, on which particular information is displayed, such as measurements, operating states, stored or received data or the like. Display on the display area, which is usually configured as a display surface, takes place on the basis of liquid crystals (LCD).

For protection against external effects, the display surface is generally covered by a transparent anti-splinter protective element, and is in fact frequently bonded to such an element. Furthermore, frame elements provide the liquid-crystal display element with mechanical stability; they may likewise be used to incorporate the liquid-crystal display element into a corresponding housing. As well as the liquid-crystal display elements, protective elements, and frame elements, a display system of the invention may comprise further components, such as housing elements and elements for regulating and controlling the display function.

The sheetlike element of the invention has a particular defined sequence of individual laminae. The sheetlike element has a carrier, which has a first adhesive layer on one of its side faces, and a metallization layer on the second side face. Arranged on the metallization layer is a blacking layer, and this blacking layer carries a second adhesive layer. A layer in the present context means any arrangement which is at least substantially two-dimensionally extended, and is aligned at least approximately parallel to the direction of principal extent of the sheetlike element.

Further to the layers described here, the structure of the sheetlike element may have further constituents; thus it is possible for further layers to be arranged on or between the above-described layers, these further layers being able to provide additional functionalities in accordance with the particular profile of requirements of the sheetlike element. They may be, for example, adhesion promoters, primers, conductive or insulating laminae, further color laminae, protective laminae, and the like. In view of the invention, however, it is important that the relative sequence of the layers with respect to one another remains, overall, maintained in the form described, in order to allow the inventive effect of the sheetlike element to be ensured.

Furthermore, it is likewise possible for a sheetlike element of the invention, in addition to the construction described here, to have individual zones in which the layer arrangement is different from this specific construction, and in which certain layers may even be absent. This may be the case, for example, when the sheetlike element of the invention is designed not in the form of a frame, which bonds the display element to a protective plate only in the shaded area of the display surface, but is instead designed for full-area bonding of the display element to a protective plate over the entire display surface, in other words both in the shaded area and in the visible area of the display element. For this purpose it is possible to use a sheetlike element which has the structure of the invention, described above, only in the zone which is arranged on the shaded area in the adhesive bond, whereas, in the zone which is arranged in the visible area of the display surface in the adhesive bond (above the actual display field), the sheetlike element is completely transparent, having therefore neither a metallization layer nor a blacking layer, and in which, in addition, neither carrier nor adhesives are colored. In connection with the concept of the invention, however, it is important with a sheetlike element of this kind that the structure according to the invention is realised in any case in the shaded area of the display surface, which is generally arranged in the form of a frame at the edge of the display surface.

A carrier for the present purposes means a substantially sheetlike film or foil which, as a mechanical support to the adhesives used, gives the sheetlike element mechanical stability. A carrier may be composed of any of the foil or film materials familiar to the skilled worker, which are transparent or may be colored—for example, of polymers such as polyester, polyethylene, polypropylene, polyamide, polyimide, polymethacrylate, polyvinyl chloride or fluorinated polymers. In addition to the use of conventional polymer films it is also possible to use those polymer films which have one or more preferential directions; these can be produced, for instance, by stretching in one or in two directions, an example being biaxially oriented polypropylene (BOPP). Further particularly suitable, on account of the excellent diecutability, are polyester films, such as those of polyethylene terephthalate (PET) or polybutylene terephthalate. The carrier may comprise the polymer film in each case individually or else in combination, as a multilayer-laminated film, for example.

As an inherent feature of their production, the carrier films generally have additives which prevent sticking (blocking) of the flat polymer films under pressure and temperature, and hence are intended to counteract the sticking together of two or more film webs to form blocks. Additives of this kind are referred to as antiblocking agents. They are conventionally incorporated into or applied to the thermoplastic polymer, for instance, where they act as non-adhering and hence adhesion-reducing spacers. For the production process of PET films, for instance, use is made accordingly of silicon dioxide, zeolites, and siliceous chalk, or chalk as antiblocking agents.

For the inventive sheetlike elements, however, it is also possible to use carriers which contain no antiblocking agents or contain such agents only in a very small fraction, if at all. In order nevertheless to be able to prevent blocking of the film webs, other measures are needed. Thus, for example, immediately after their manufacture, the thermally deformable (thermoplastic) films may be applied to temporary carriers or process films, which themselves are not thermally deformable and on which the thermoplastic films are able to cool prior to being wound. This prevents two thermoplastic film plies being in direct contact with one another during the cooling process. As a result, the thermoplastic film material is unable to block. Temporary carrier films of this kind may be wound up together with the thermoplastic film materials.

Another means of preventing blocking of the films is, for example, to provide the top faces of the films with texturing one or both sides. This may take the form, for example, of texturing with vertical dimensions in the range of a few nanometers, typically with a maximum height of 400 nm. These nanometer-sized structures can be applied using conventional shaping techniques, as for example by means of embossing. With the aid of these nanostructures, a defined roughness is produced deliberately on the top face of the carrier films, and prevents blocking of the films, without adversely affecting their optical properties, such as transparency. Texturing of this kind may be provided over the full area of the carrier or only locally, in other words at individual locations on the carrier surface. Instead of nanostructuring it is also possible to take any desired other measures by means of which the roughness of the film surface is deliberately increased. Thus, for example, the film carrier may be perforated in a marginal section (microscopically or even macroscopically). Through this means it is possible to store the carrier with the perforated sections, the perforation meaning that the carrier does not block. After the carrier film has been unwound, this region can be removed, and so the end product does not have any perforation.

In order to prevent the occurrence of optical defects, the carrier must have no more than a very low level of antiblocking agents on the side on which there is an absorbing and/or reflecting layer on the carrier. In the present case, for instance, this is the metallization layer and the blacking layer. On its top face in contact with the metallization layer, therefore, the carrier may have an antiblocking agent content of not more than 4000 ppm, sensibly of less than 500 ppm, or even no antiblocking agent at all. In order to be able to dispense with antiblocking agent on this side and hence to reduce the number of potential optical defects, the top face of the carrier here preferably exhibits nanoembossing.

As carriers it is usual to use films having a thickness from a range from 5 μm to 250 μm, preferably from a range from 8 μm to 50 μm, or even only from a range from 12 μm to 36 μm. With a view to the technical adhesive properties, very thin PET films are preferred, i.e., films having a thickness of not more than 12 μm. Such films permit the production of a very flexible sheetlike element which conforms outstandingly to the surface texture and surface roughness of the substrates to be adhesively bonded and hence allows a stable connection. With a carrier of such a kind it is possible, for example, to produce sheetlike elements having an overall thickness of around 50 μm.

In order to improve the anchorage of varnish layers or metallic layers on the carrier film it is possible for the top sides of the film to be pretreated. For this purpose it is possible in principle to employ all customary and suitable methods of improving the adhesion, as for example the etching of the top film side, with trichloroacetic or trifluoroacetic acid, for instance, electrostatic pretreatment, as for instance in a corona treatment or plasma treatment, or treatment with a primer, as for instance with Saran.

The carrier films may be transparent or may possess coloring, through the addition to the film materials, for instance, of dyes or color pigments as additives. Suitable in principle are all those particles or pigments that are familiar to the skilled person, examples being titanium dioxide particles or barium sulfate particles for whitening or carbon black for blackening. In order to ensure optimum strength of the sheetlike element, however, the dimensions of the particles ought to be lower than the thickness of the carrier film. Optimal colorations can be achieved with 5% to 40% by weight particle fractions, relative to the mass of the film material. Particularly in the case of the aforementioned very thin PET films, however, it is not possible to embed, into a short optical path length of this kind, a sufficiently large quantity of dye molecules or colorant pigments into the polyester in order to produce high light absorption. That can only be achieved if the thin PET films are provided on one or both sides with a metallization layer.

A metallization layer in the present context is a layer which is metallically lustrous (i.e., which reflects irradiated light) and which at the same time compensates any unevennesses or surface roughnesses in the carrier film. As a result of the use of a metallization layer on the carrier of the sheetlike element, a reduction is achieved in the amount of light not transmitted, overall, by the sheetlike element. The carrier may have a metallization layer on one or both sides. In accordance with the invention, the metallization layer is provided on that side of the carrier that likewise has the blacking layer. In an equivalent embodiment, the metallization layer is disposed as well or exclusively on that side of the carrier which is opposite the blacking layer, and so the metallization layer is disposed between the translucent white adhesive and the carrier. The lamina thicknesses thus achieved for a metallization layer are situated typically in a range between 5 nm and 200 nm.

A metallization layer may be constructed in any customary and any suitable way; as a metallization layer it is common to use a lamina which is composed of a metallic varnish or of a metallic lamina. To avoid any wavelength-dependent reflection in the visible region of light, it is normal for this purpose to use a silver or white-silver material. As a metallic varnish it is common to use a binder matrix blended with silver color pigments or particles of silver. Suitable binder matrices include, for instance, polyurethanes or polyesters which have a high refractive index and a high transparency. The color pigments may alternatively be used in a polyacrylate matrix or polymethacrylate matrix and then cured as a varnish. To enhance the reflection, varnish laminae of this kind can be applied and cured and subsequently polished.

As a metallic lamina it is common to use a metal, such as aluminum or silver, which is applied to the top side of the film by vapor deposition, as by means of sputtering, for example, although for this purpose it is of course also possible to use all other metals suitable in respect of their corrosion resistance and their reflection capacity. Where a particularly high-grade optical metallization layer is to be obtained, the vapor deposition regime should be aimed at depositing the metal in an extremely homogeneous, planar layer. A uniform layer of this kind can be achieved in accordance with the invention, for instance, by using a carrier material whose top side for metallization contains no or at best only a small amount of antiblocking agents. For this purpose, for instance, a plasma-pretreated PET film can be vapor-coated with aluminum in one workstep.

The blacking layer comprises a black color varnish which is not pressure-sensitively adhesive at room temperature and/or a black primer which is not pressure-sensitively adhesive at room temperature. A blacking layer in the present context is understood to be any layer which, when applied to a substrate, causes that substrate to appear black, so that the light is almost completely, or at least to a large extent, absorbed therein. Since the blacking layer in the completed electronic devices is used with an outward orientation, it is employed in accordance with the invention for absorbing the ambient light.

In accordance with the invention the blacking layer is applied to the metallization layer and hence joins the metallization layer to the second adhesive. Equivalent to this as well, however, is an arrangement in which the blacking layer is applied directly to the carrier and the latter is joined directly to the second adhesive. The blacking layer may be of one-part construction or may have two or more individual laminae. The thickness of a blacking layer of this kind is typically between 1 and 25 μm.

When a blacking layer of this kind is used, therefore, the transmittance of the double-sidedly bondable sheetlike element in the wavelength range between 300 nm and 800 nm ought to be less than 0.5%, preferably less than 0.1%, and more preferably less than 0.01%. Since the absorption properties of the sheetlike element are determined primarily by the blacking layer, therefore, the blacking layer ought to possess a corresponding transmittance.

The blacking layer typically comprises at least one color-bearing varnish lamina or a primer lamina. A black varnish lamina has as its varnish matrix a curing binder matrix, which may be, for example, a thermosetting or radiation-curing system, with black color pigments mixed into it. Typical varnish matrices are, for instance, polyesters, polyurethanes, polyacrylates or polymethacrylates. They may have further additives in accordance with the profile of requirements of the particular varnish. In accordance with the invention, without restriction, any suitable color varnish can be used as color varnish.

Instead of a color varnish, the blacking layer may also be a black-colored primer which serves to enhance the adhesion of the adhesive to the carrier film. As an option it is also possible to use a color varnish which serves additionally as a primer. Hence, accordingly, through the use of a blacking layer which itself is not pressure-sensitively adhesive and hence cannot be used as an adhesive, it is possible to achieve an overall improvement in the anchorage of an adhesive to the sheetlike element.

As color-bearing particles the blacking layer—that is, the color varnish or the primer—comprises black color pigments; advantageously these are carbon-black particles or graphite particles. Where the blacking layer contains more than 20% by weight of color-bearing particles of this kind, for the purpose of achieving a minimal optical transmittance, the result of this may also be electrical conductivity parallel to the main direction of the sheetlike element, particularly when carbon black or graphite is used. In this way, sheetlike elements with antistatic properties are obtained, with the ability to prevent voltage breakdown in the electronics or the liquid-crystalline-switching cell as a result of static charges and hence to prevent damage to the electronic device.

In accordance with the invention the sheetlike element has a first adhesive layer and a second adhesive layer. The first adhesive layer is a layer which comprises a first adhesive. The second adhesive layer is a layer which comprises a second adhesive. The basic construction and basic composition of the first adhesive and of the second adhesive may be different or else—as an exception—identical.

As a feature essential to the invention, the first adhesive contains over its entire thickness color pigments which give it a translucent white coloring; this is achieved through the presence of white pigments in the adhesive at a mass fraction of at least 2% by weight and not more than 10% by weight, preferably of at least 4% by weight and not more than 8% by weight. For specialty applications the first adhesive may further comprise other color pigments; these, however, should not result in the first adhesive coating, constructed from the first adhesive, losing its translucent appearance. The second adhesive usually contains no color pigments, but for specialty applications may contain any desired color pigments, in order, for instance, to give the electronic device a particular external appearance.

The first adhesive coating is typically applied directly to the carrier; equivalent to this—particularly when using two metallization layers, one on each side face of the carrier—is an arrangement in which the first adhesive is applied to the surface of a metallization layer. The second adhesive coating is applied directly to the blacking layer. In accordance with the invention, the application of the second adhesive coating directly to the metallization layer or even directly to the carrier shall be excluded.

The first adhesive coating and the second adhesive coating typically have lamina thicknesses from a range from 5 μm to 250 μm. The first adhesive coating and the second adhesive coating may further be identical in construction in terms of their lamina thickness, or else may differ.

The first and second adhesives are each pressure-sensitive adhesives. Pressure-sensitive adhesives are adhesives which permit durable adhesive bonding to the substrate under just relatively gentle applied pressure, and which, after use, may be redetached from the substrate substantially without residue. The bondability of the adhesives derives from their adhesive properties, and the redetachability from their cohesive properties. In principle, in accordance with the invention, it is possible to use all customary and suitable pressure-sensitive adhesive systems.

As first adhesive and as second adhesive it is preferred to use pressure-sensitive adhesives based on natural rubbers, synthetic rubbers, silicones or acrylates. It is of course also possible to use all other pressure-sensitive adhesives known to the skilled person, such as those listed, for example, in the “Handbook of Pressure Sensitive Adhesive Technology” by Donatas Satas (van Nostrand, New York 1989).

For natural rubber adhesives, the natural rubber used in each case may be comminuted and additized. For instance, a natural rubber may be milled, in which case milling should take place no more than down to a molecular weight (weight average) of 100 000 Daltons, but preferably not less than 500 000 Daltons.

In the case of rubbers or synthetic rubbers as starting material for the adhesive there are a host of different systems that can be employed. For instance, natural rubbers or synthetic rubbers, or any desired mixtures (blends) of natural rubbers and/or synthetic rubbers, may be used. Natural rubber may be selected in principle from all available grades and types, such as crepe, RSS, ADS, TSR or CV grades, for example, the selection normally being made in accordance with the profile of requirements of the adhesive in regard of the requisite purity and viscosity.

Similarly, it is also possible to use any desired synthetic rubbers, with practical considerations having shown the following synthetic rubbers to be particularly advantageous: those from the group of the randomly copolymerized styrene-butadiene rubbers (SBR), the butadiene rubbers (BR), the synthetic polyisoprenes (IR), the butyl rubbers (IIR), the halogenated butyl rubbers (XIIR), the acrylate rubbers (ACM), the ethylene-vinyl acetate copolymers (EVA), and the polyurethanes (in each case individually and also in mixtures).

For the targeted control of the properties of such rubbers it is possible for them to be admixed with additives, examples being thermoplastic elastomers for enhancing the processing properties, which in that case may be present in the adhesive at a weight fraction of about 10% by weight to 50% by weight, based on the overall elastomer fraction. Purely by way of example, reference is made in this context to the particularly compatible styrene-isoprene-styrene grades (SIS) and to the styrene-butadiene-styrene grades (SBS).

Preferably, however, acrylate-based pressure-sensitive adhesives are employed. Adhesives of this kind are constructed from acrylic monomers. The group of acrylic monomers is composed of all compounds having a structure which can be derived from the structure of unsubstituted or substituted acrylic acid or methacrylic acid or else from esters of these compounds (these options are designated collectively by the term “(meth)acrylates”. These monomers can be described by the general formula CH₂═C(R′)(COOR″), where the radical R′ may be a hydrogen atom or a methyl group and the radical R″ may be a hydrogen atom or else is selected from the group of saturated, unbranched or branched, substituted or unsubstituted C₁ to C₃₀ alkyl groups.

The (meth)acrylate-based polymers of these pressure-sensitive adhesives are obtainable for instance through free-radical polymerization, the polymer frequently having an acrylic monomer content of 50% by weight or more.

The monomers are typically selected such that the resulting polymer materials can be used, at room temperature or higher temperatures, as pressure-sensitive adhesives (PSAs), possessing pressure-sensitive adhesive properties in accordance with the “Handbook of Pressure Sensitive Adhesive Technology” by Donatas Satas (van Nostrand, New York 1989).

(Meth)acrylate PSAs can be obtained preferably by polymerization of a monomer mixture which comprises acrylic esters and/or methacrylic esters and/or their free acids with the formula CH₂═C(R′)(COOR″′), where R′ is H or CH₃ and R″′ is H or an alkyl chain having 1-20 C atoms. The poly(meth)acrylates typically have molecular weights (molar masses) M_{w} of more than 200 000 g/mol.

As monomers it is possible for instance to use acrylic monomers or methacrylic monomers which comprise acrylic and methacrylic esters having alkyl groups of 4 to 14 C atoms, typically of 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and also their branched isomers such as, for instance, isobutyl acrylate, 2-ethylhexyl acrylate, 2-ethylhexyl methacrylate, isooctyl acrylate or isooctyl methacrylate.

Other monomers which can be used are monofunctional acrylates and methacrylates of bridged cycloalkyl alcohols, consisting of at least 6 C atoms. The cycloalkyl alcohols may also be substituted, as for example by C₁ to C₆ alkyl groups, halogen atoms or cyano groups. Specific examples are cyclohexyl methacrylate, isobornyl acrylate, isobornyl methacrylate, and 3,5-dimethyladamantyl acrylate.

It is possible, furthermore, to use monomers which have polar groups, such as, for example, carboxyl radicals, sulfonic acid, phosphonic acid, hydroxyl, lactam, lactone, N-substituted amide, N-substituted amine, carbamate, epoxy, thiol, alkoxy or cyano radicals, and also ether groups or the like.

Examples of suitable moderately basic monomers are singly or doubly N-alkyl-substituted amides, more particularly acrylamides. Specific examples are N,N-di-methylacrylamide, N,N-dimethylmethacrylamide, N-tert-butylacrylamide, N-vinylpyrrolidone, N-vinyllactam, dimethylaminoethyl acrylate, dimethylaminoethyl meth-acrylate, diethylaminoethyl acrylate, diethylaminoethyl methacrylate, N-methylolacrylamide, N-methyl-olmethacrylamide, N-(butoxymethyl)methacrylamide, N-(ethoxymethyl)acrylamide, N-isopropylacrylamide, this enumeration not being conclusive.

Further examples of monomers are selected on the basis of their functional groups that can be utilized for crosslinking, such as hydroxyethyl acrylate, hydroxyethyl methacrylate, hydroxypropyl acrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl acrylate, 2-butoxyethyl methacrylate, cyanoethyl acrylate, cyanoethyl methacrylate, glyceryl methacrylate, 6-hydroxyhexyl methacrylate, vinylacetic acid, tetrahydrofurfuryl acrylate, β-acryloyloxypropionic acid, trichloroacrylic acid, fumaric acid, crotonic acid, aconitic acid, dimethyl acrylic acid, this enumeration not being conclusive.

Additionally contemplated as monomers are vinyl compounds, more particularly vinyl esters, vinyl ethers, vinyl halides, vinylidene halides, vinyl compounds with aromatic rings and heterocycles in α position. Here again, certain examples may be nonexclusively stated, such as vinyl acetate, vinyl formamide, vinyl pyridine, ethyl vinyl ether, vinyl chloride, vinylidine chloride, and acrylonitrile.

The comonomer compositions in this context may also be selected such that the PSAs can be employed as heat-activatable PSAs, which become pressure-sensitively adhesive only under temperature exposure and optional pressure, and which, after bonding and cooling, develop a high bond strength to the substrate as a result of solidification. Systems of this kind have glass transition temperatures T_{G} of 25° C. or more.

Other examples of monomers may be photoinitiators having a copolymerizable double bond, more particularly those selected from the group containing Norrish I or Norrish II photoinitiators, such as benzoin acrylates or acrylated benzophenones (in commerce under the name Ebecryl P36® from UCB). In principle it is possible to employ all photoinitiators known to the skilled person that, when irradiated with UV light in the polymer, bring about crosslinking via a free-radical mechanism. A general overview of photoinitiators which can be used, and which in that case may be functionalized with at least one double bond, is given by Fouassier in “Photoinitiation, Photopolymerization and Photocuring: Fundamentals and Applications” (Hanser-Verlag, Munich 1995), and also—as a supplement—by Carroy et al. in “Chemistry and Technology of UV and EB Formulation for Coatings, Inks and Paints” (Oldring (Ed.), 1994, SITA, London).

Moreover, further monomers may be added to the comonomers described above, the homopolymer of such monomers possessing a relatively high glass transition temperature. Suitable such components include aromatic vinyl compounds such as styrene, for instance, in which case the aromatic moieties may preferably have an aromatic core of C₄ to C₁₈ units and optionally may also contain heteroatoms. Examples of such are, for instance, 4-vinylpyridine, N-vinylphthalimide, methylstyrene, 3,4-dimethoxystyrene, 4-vinylbezoic acid, benzyl acrylate, benzyl methacrylate, phenyl acrylate, phenyl methacrylate, t-butylphenyl acrylate, t-butylphenyl methacrylate, 4-biphenyl acrylate, 4-biphenyl methacrylate, 2-naphthyl acrylate, 2-naphthyl methacrylate, and mixtures of these monomers, this enumeration not being conclusive.

Overall, the compositions for the adhesives can be varied within wide margins by changing the nature and proportion of the reactants. Similarly, further product properties can be deliberately controlled, such as thermal or electrical conductivity, for example, through addition of auxiliaries. For this purpose, an adhesive may comprise further formulating ingredients and/or auxiliaries such as, for example, plasticizers, fillers (for example, fibers, solid or hollow glass beads, microbeads made of other materials, silica, silicates), nucleating agents, electrically conductive materials (for instance, undoped or doped conjugated polymers or metal salts), expandants, compounding agents and/or ageing inhibitors (such as primary or secondary antioxidants) or light stabilizers. The formulating of the adhesive with such further ingredients as, for example, fillers and plasticizers is likewise state of the art.

In order to adapt the specific technical adhesive properties of the adhesive to the particular application, the PSAs may be admixed with bond strength enhancing or tackifying resins. Resins which can be used as such resins—referred to as tackifier resins—include, without exception, all tackifier resins that are known and are described in the literature. Typical tackifier resins are, for instance, pinene resins, indene resins, and rosins, their disproportionated, hydrogenated, polymerized, and esterified derivatives and salts, the aliphatic and aromatic hydrocarbon resins, terpene resins and terpene-phenolic resins, and also C₅, C₉, and other hydrocarbon resins. These and further resins may be used individually or in any desired combinations in order to adjust the properties of the resultant adhesive in accordance with the application. Generally speaking, it is possible to use all resins that are compatible (soluble) with the thermoplastic material in question, more particularly aliphatic, aromatic or alkylaromatic hydrocarbon resins, hydrocarbon resins based on pure monomers, hydrogenated hydrocarbon resins, functional hydrocarbon resins, and natural resins. Express reference may be made to the depiction of the state of knowledge in “Handbook of Pressure Sensitive Adhesive Technology” by Donatas Satas (van Nostrand, 1989).

It should be ensured here that, rationally, resins are used that are highly compatible with the polymer and are substantially transparent. These requirements are met by resins including some hydrogenated or part-hydrogenated resins.

It is possible, furthermore, in addition, to admix crosslinkers and also crosslinking promoters. Suitable crosslinkers for electron-beam crosslinking and UV crosslinking are, for example, difunctional or polyfunctional acrylates, difunctional or polyfunctional isocyanates (including those in blocked form) or difunctional or polyfunctional epoxides. Furthermore, it is also possible to add thermally activable crosslinkers to the reaction mixture, such as Lewis acids, metal chelates or polyfunctional isocyanates.

For optional crosslinking of the adhesives it is possible to add any desired suitable initiators and/or crosslinkers to them. Hence the adhesives may, for example, for subsequent crosslinking during irradiation with ultraviolet light (UV), contain UV-absorbing photoinitiators. Examples of suitable photoinitiators are benzoin ethers such as, for instance, benzoin methyl ether or benzoin isopropyl ether, substituted acetophenones such as, for instance, dimethoxyhydroxyacetophenone or 2,2-diethoxyacetophenone (available as Irgacure 651® from Ciba Geigy), 2,2-dimethoxy-2-phenyl-1-phenylethanone, substituted α-ketols such as, for instance, 2-methoxy-2-hydroxypropiophenone, aromatic sulfonyl chlorides such as, for instance, 2-naphthylsulfonyl chloride, and photoactive oximes such as, for instance, 1-phenyl-1,2-propanedione-2-(O-ethoxycarbonyl)oxime.

The photoinitiators and other initiators of the Norrish I or Norrish II type that may be used may also be in substituted form and may have any desired suitable radicals, examples being benzophenone, acetophenone, benzyl, benzoin, hydroxyalkylphenone, phenyl cyclohexyl ketone, anthraquinone, trimethylbenzoylphosphine oxide, methylthiophenylmorpholinoketone, aminoketone, azobenzoin, thioxanthone, hexarylbisimidazole, triazine or fluorenone radicals, it being possible of course for these radicals in turn to be substituted, as for instance by one or more halogen atoms, alkyloxy groups, amino groups and/or hydroxyl groups. A representative overview in this context is offered by Fouassier in “Photoinitiation, Photopolymerization and Photocuring: Fundamentals and Applications” (Hanser-Verlag, Munich 1995), and also—as a supplement—by Carroy et al. in “Chemistry and Technology of UV and EB Formulation for Coatings, Inks and Paints” (Oldring (Ed.), 1994, SITA, London).

For the polymerization the monomers are selected such that the resultant bondable polymers can be used at room temperature or higher temperatures as PSAs (and optionally also as heat-activable adhesives), more particularly such that the resulting base polymers have pressure-sensitive adhesive properties in the meaning of the “Handbook of Pressure Sensitive Adhesive Technology” by Donatas Satas (van Nostrand, New York 1989). Targeted control of the glass transition temperature can be brought about in this case, for instance, via the composition of the monomer mixture on which the polymerization is based.

To obtain a polymer glass transition temperature TG of T_{g}≦25° C. for PSAs, the monomers, for instance, are selected, and the quantitative composition of the monomer mixture selected, in such a way that the desired glass transition temperature T_{g} value for the polymer is given in accordance with equation (E1), in analogy to the equation presented by Fox (cf. T. G. Fox, Bull. Am. Phys. Soc. 1 (1956) 123), as follows:

$$\frac{1}{{T}_{g}} = {\sum }_{n} \frac{{W}_{n}}{{T}_{g , n}} \qquad ( E1 )$$

In this equation, n represents the serial number of the monomers used, wₙ the mass fraction of the respective monomer n (in % by weight), and T_{g, n} the respective glass transition temperature of the homopolymer of the respective monomer n (in K).

The poly(meth)acrylate PSAs may be prepared in the customary synthesis processes for such polymers, as for example in conventional free-radical polymerizations or in controlled free-radical polymerizations.

For the polymerizations which proceed by a free-radical mechanism, initiator systems are used which comprise other free-radical initiators for the polymerization, more particularly thermally decomposing free-radical-forming azo or peroxo initiators. Suitable in principle, however, are all initiators that are familiar to the skilled person and customary for acrylates. The production of C-centered free radicals is described, for instance, in Houben-Weyl, “Methoden der Organischen Chemie” (vol. E 19a, pp. 60-147). These methods can be employed, among others, analogously.

Examples of free-radical sources of suitable free-radical initiator systems are, for instance, peroxides, hydroperoxides, and azo compounds, for instance potassium peroxodisulfate, dibenzoyl peroxide, cumene hydroperoxide, cyclohexanone peroxide, di-t-butyl peroxide, azodiisobutyronitrile (AIBN), cyclohexylsul-fonyl acetyl peroxide, diisopropyl percarbonate, t-butyl peroctoate, benzpinacol, and the like. Thus for example, as a free-radical initiator it is possible to use 1,1′-azobis(cyclohexanecarbonitrile), which is available commercially from the company DuPont under the name Vazo 88™.

The number-average molecular weights Mₙ of the adhesives formed in the free-radical polymerization are selected for example such that they are within a range from 200 000 to 4 000 000 g/mol; specifically for use as hotmelt PSAs, PSAs are prepared which have average molecular weights Mₙ of 400 000 to 1 400 000 g/mol. The average molecular weight is determined via size extrusion chromatography (SEC or GPC) or matrix-assisted laser desorption/ionization coupled with mass spectrometry (MALDI-MS).

The polymerization may be conducted in bulk, in the presence of one or more organic solvents, in the presence of water, or in mixtures of organic solvents and water. In this context the amount of solvent used is typically to be kept as small as possible. Suitable organic solvents are, for instance, pure alkanes (for example, hexane, heptane, octane, isooctane), aromatic hydrocarbons (for example, benzene, toluene, xylene), esters (for example, ethyl acetate, propyl acetate, butyl acetate or hexyl acetate), halogenated hydrocarbons (for example, chlorobenzene), alkanols (such as, for example, methanol, ethanol, ethylene glycol, ethylene glycol monomethyl ether), and ethers (for example, diethyl ether, dibutyl ether), and also mixtures thereof. Aqueous polymerization reactions can be admixed with a water-miscible or hydrophilic cosolvent in order to ensure that the reaction mixture is present as a homogeneous phase during the monomer conversion. Use may be made, for example, of cosolvents from the group consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxyether derivatives, amino alcohols, ketones, and the like, and also derivatives and mixtures thereof.

The polymerization time may—depending on conversion and temperature—be between 2 and 72 hours. The higher the reaction temperature that can be chosen (in other words, the higher the thermal stability of the reaction mixture), the shorter the reaction time may turn out to be.

It is possible, furthermore, to conduct the polymerization of the (meth)acrylate PSAs in bulk, without addition of solvents. This may occur in accordance with customary methods, as for instance by means of prepolymerization. In that case the polymerization is initiated with light from the UV region of the spectrum, and the reaction is continued up to a low conversion of around 10-30%. The highly viscous prepolymer material obtained in this way can then be processed further in the form of a polymer syrup, it being possible, for example, first to store the reaction mixture welded into films—in ice cube tubes, for instance—and, finally, to carry out polymerization in water through to a high ultimate conversion.

The pellets obtained in this way can be used, for instance, as an acrylate hotmelt adhesive, the melting then being carried out on film materials of a type which are compatible with the polyacrylate product obtained.

Furthermore, a polymer for a poly(meth)acrylate PSA can be prepared in a living polymerization, as for example in an anionic polymerization, for which, typically, inert solvents may be employed as the reaction medium, for instance aliphatic and cycloaliphatic hydrocarbons or aromatic hydrocarbons.

The living polymer in this case is typically represented by the general formula P_{L}(A)-Me, where Me is a metal from the group I of the periodic table of the elements (for example, lithium, sodium or potassium) and P_{L}(A) is a growing polymer block of the acrylate monomers. The molecular weight of the polymer is dictated by the ratio of initiator concentration to monomer concentration.

Suitable polymerization initiators for this purpose include, for instance, n-propyllithium, n-butyllithium, sec-butyllithium, 2-naphthyllithium, cyclohexyllithium or octyllithium, this enumeration having no claim to completeness. Also known, and able to be used as well, for the polymerization of acrylates are initiators based on samarium complexes (Macromolecules, 1995, 28, 7886).

Furthermore, it is also possible to use difunctional initiators such as, for example, 1,1,4,4-tetraphenyl-1,4-dilithiobutane or 1,1,4,4-tetraphenyl-1,4-dilithio-isobutane. Use may likewise be made of coinitiators such as, for example, lithium halides, alkali metal alkoxides or alkylaluminum compounds. Hence, for instance, the ligands and coinitiators may be selected such that acrylate monomers such as n-butyl acrylate and 2-ethylhexyl acrylate, for example, can be polymerized directly and do not have to be generated in the polymer by transesterification with the corresponding alcohol.

For the initiation of a conventional polymerization, the supply of heat is essential for thermally decomposing initiators. For thermally decomposing initiators of this kind, the polymerization, depending on type of initiator, can be started by heating at 50° C. to 160° C. All suitable catalysts may be used.

In order to obtain poly(meth)acrylate PSAs having particularly narrow molecular weight distributions, controlled free-radical polymerizations are conducted as well. For the polymerization, use is then preferably made of a control reagent having the following general formula:

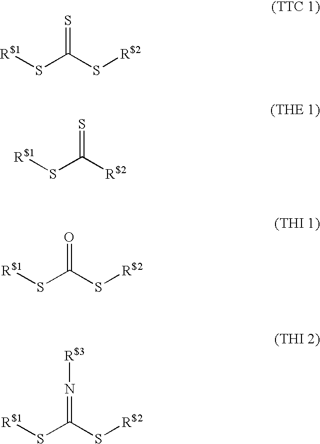

R^{$1} and R^{$2} for this purpose may be selected identically or independently of one another, and R^{$3} where present may be selected identically or differently to one or both groups R^{$1} and R^{$2}. These radicals are rationally selected from one of the following groups:
C₁ to C₁₈ alkyl radicals, C₃ to C₁₈ alkenyl radicals, and C₃ to C₁₈ alkynyl radicals, in each case linear or branched;
C₁ to C₁₈ alkoxy radicals;
C₁ to C₁₈ alkyl radicals, C₃ to C₁₈ alkenyl radicals, and C₃ to C₁₈ alkynyl radicals, in each case substituted by at least one OH group or halogen atom or silyl ether;
C₂ to C₁₈ heteroalkyl radicals having at least one O atom and/or a group NR* in the carbon chain, where R* is any desired radical, more particularly an organic radical;
C₁ to C₁₈ alkyl radicals, C₃ to C₁₈ alkenyl radicals, and C₃ to C₁₈ alkynyl radicals, in each case substituted by at least one ester group, amine group, carbonate group, cyano group, isocyano group and/or epoxide group, and/or by sulfur;
C₃ to C₁₂ cycloalkyl radicals;
C₆ to C₁₈ aryl radicals and C₆ to C₁₈ benzyl radicals;
hydrogen.

Control reagents of type TTC I originate typically from classes of compound of the types listed above, further specified as follows:

The respective halogen atoms are chlorine and/or bromine and/or optionally also fluorine and/or iodine.

The alkyl, alkenyl, and alkynyl radicals in the various substituents have linear and/or branched chains.

Examples of alkyl radicals which contain 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a typical C₂ to C₁₈ heteroalkyl radical having at least one O atom in the carbon chain is —CH₂—CH₂—O—CH₂—CH₃.

Examples of C₃ to C₁₂ cycloalkyl radicals include cyclopropyl, cyclopentyl, cyclohexyl, and trimethylcyclohexyl.

Examples of C₆ to C₁₈ aryl radicals include phenyl, naphthyl, benzyl, 4-tert-butylbenzyl or other substituted phenyls such as, for instance, those substituted by an ethyl group and/or by toluene, xylene, mesitylene, isopropylbenzene, dichlorobenzene or bromotoluene.

The above listing in this context merely offers examples of the particular classes of compound, and is therefore not complete.

As a further suitable preparation procedure, reference may be made to a variant of RAFT polymerization (reversible addition-fragmentation chain transfer polymerization). A polymerization procedure of this kind is described exhaustively in WO 98/01478 A1, for example. In this case polymerization takes place usually only to low conversions, in order to produce molecular weight distributions that are as narrow as possible. As a result of the low conversions, however, these polymers cannot be used as PSAs and more particularly not as hotmelt PSAs, since the high fraction of residual monomers would adversely influence the technical adhesive properties, the residual monomers would contaminate the solvent recyclate on concentration, and the self-adhesive tapes manufactured therewith would exhibit severe outgassing behavior. To circumvent the disadvantage of low conversions, the polymerization can be initiated repeatedly.

As a further controlled free-radical polymerization method it is possible to carry out nitroxide-controlled polymerizations. For free-radical stabilization in this case it is possible to use customary free-radical stabilizers, for instance nitroxides of the type (NIT 1) or (NIT 2):

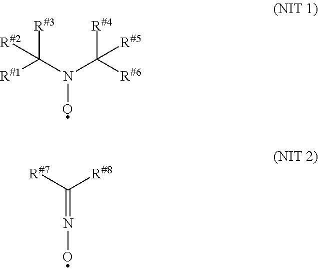

where R^{#1}, R^{#2}, R^{#3}, R^{#4}, R^{#5}, R^{#6}, R^{#7}, R^{#8} independently of one another may represent the following atoms or groups:
i) halides such as chlorine, bromine or iodine, for example,
ii) linear, branched, cyclic, and heterocyclic hydrocarbons having 1 to 20 carbon atoms, and being saturated, unsaturated or aromatic,
iii) esters —COOR^{#9}, alkoxides —OR^{#1C} and/or phosphonates —PO(PR^{#11})₂, where R^{#9}, R^{#10} and/or R^{#11} represent radicals from group ii) above.

Compounds of the structure (NIT 1) or (NIT 2) can also be attached to polymer chains of any kind (primarily in the sense that at least one of the abovementioned radicals constitutes a polymer chain of this kind) and therefore may be utilized as macroradicals or macroregulators in the synthesis of block copolymers.

As controlled regulators for the polymerization it is likewise possible to use compounds of the following types:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide

A series of further polymerization methods by which adhesives can be prepared in an alternative procedure may be selected from the state of the art:

Thus U.S. Pat. No. 4,581,429 A discloses a controlled-growth free-radical polymerization process which uses as initiator a compound of the general formula R′R″N—O—Y, in which Y is a free radical species which is able to polymerize unsaturated monomers. The reactions, however, generally have low conversions. A particular problem is the polymerization of acrylates, which proceeds only to very low yields and with low molecular masses. WO 98/13392 A1 describes open-chain alkoxyamine compounds which have a symmetrical substitution pattern. EP 735 052 A1 discloses a process for preparing thermoplastic elastomers having narrow molecular weight distributions. WO 96/24620 A1 describes a polymerization process in which specific free-radical compounds such as, for example, phosphorus-containing, imidazolidine-based nitroxides are used. WO 98/44008 A1 discloses specific nitroxides based on morpholines, piperazinones, and piperazinediones. DE 199 49 352 A1 describes heterocyclic alkoxyamines as regulators in controlled-growth free-radical polymerizations. It is possible, furthermore, for corresponding developments of the alkoxyamines and of the corresponding free nitroxides to improve the efficiency for the preparation of polyacrylates.

As a further controlled polymerization method it is possible, for the synthesis of the copolymers, to use atom transfer radical polymerization (ATRP), in which case initiators used are typically monofunctional or difunctional secondary or tertiary halides, and the halide or halides is or are abstracted using complexes of Cu, Ni, Fe, Pd, Pt, Ru, Os, Rh, Co, Ir, Ag or Au (cf., for instance, EP 824 110 A1, EP 0 824 111 A1, EP 826 698 A1, EP 841 346 A1 or EP 850 957 A1). Various possibilities of ATRP are described, furthermore, in U.S. Pat. No. 5,945,491 A, U.S. Pat. No. 5,854,364 A, and U.S. Pat. No. 5,789,487 A.

As already stated, the basic construction of the first adhesive and of the second adhesive may be identical or different. In this context it should be borne in mind that certain compositions can be used only for one of the two adhesives. For instance, fillers, which serve as black color pigments, graphite or carbon black for example, may be present exclusively in the second adhesive, although this is usually selected to be highly transparent.

Furthermore, in accordance with the invention, the first adhesive must have a white pigment. White pigments are admixed to the polymeric constituents of the adhesive, in the form of white, color-bearing particles. As the white pigment it is possible to use any customary white pigments, examples being titanium dioxide, zinc oxide or barium sulfate. Even in the region of medium amounts for addition (for instance, above an additization level of 10% by weight), there may be not only a diffuse scattering but also a directed reflection of high light intensities. In accordance with the invention, therefore, the additization should be selected at lower than 10% by weight.

For the optimum coloring of the PSA laminae, the particle size distribution of the white color pigments is of great importance. Hence not only the average particle diameter but also the maximum particle diameter as well should be smaller than the overall thickness of the adhesive layer. It is sensible to employ particles having an average particle diameter from a range from 50 nm to 5 μm, preferably from 100 nm to 3 μm or even only from 200 nm to 1 μm. Particle sizes of this kind can be obtained in a so-called top-down approach by comminution of macroscopic material in ball mills with subsequent sieve fractionation, or else in can be produced in a so-called bottom-up approach by deliberate particle growth in the solution, by wet-chemical means.

The quality of a coloration thus obtained is also determined by the homogenous distribution of the color particles in the PSA. In order to obtain optimum results, the color particles in the PSA may be subjected to an intensive mixing operation, as for instance using a high-performance dispersing appliance, an example being an appliance of the Ultraturrax™ type, by means of which the color particles are disrupted still further and distributed homogeneously in the PSA matrix.

The resulting adhesives can be applied as first adhesive and as second adhesive to the sheetlike element, after the sheetlike element has been provided beforehand with the metallization layer and the blacking layer. In order to increase the anchorage of the adhesive on the particular application base—in other words, on the carrier, on the metallization layer or on the blacking layer—it is possible for the application base to be subjected to pretreatment prior to application of the adhesive, as for example to a corona treatment or plasma treatment, the application of a primer from the melt or from solution, or else chemical etching. Particularly in the context of the pretreatment of a black varnish lamina, however, it is sensible in the case of corona treatment to minimize the corona power selected, in order to prevent the burning of pinholes into the varnish.

Suitable application methods include all customary and suitable application methods. For example the adhesive may be applied from solution, with solvent remaining in the adhesive being removable by means of heat supply, in a drying tunnel, for example. Under such conditions it is also possible for thermal post-crosslinking to be initiated at the same time.

A further possibility is to design the adhesives as hotmelt systems, so that the adhesive can be applied from the melt. It may also be necessary to remove the solvent from the adhesive, for which purpose, in principle, all methods known to the skilled person are employed. Preferably, for instance, concentration may be carried out in an extruder, such as in a twin-screw or single-screw extruder, for example. The twin-screw extruder may be operated co-rotatingly or counter-rotatingly. The solvent and/or, where appropriate, water is distilled off preferably over two or more vacuum stages. In addition, depending on the distillation temperature of the solvent, counter-heating may take place. For the sheetlike element it is advantageous to use adhesives whose residual solvent fractions amount to less than 1%, preferably less than 0.5% or even less than 0.2%. The hotmeltable adhesive is processed further from the melt.

Coating with a hotmeltable adhesive of this kind may be carried out by any desired suitable methods. Thus, for example, it is possible to apply such adhesives via a roll coating method. Various roll coating methods are described comprehensively in “Handbook of Pressure Sensitive Adhesive Technology” by Donatas Satas (van Nostrand, New York 1989). As it were, it is also possible to apply the adhesive to the sheetlike element via a melt die or by means of an extruder. Extrusion coating is carried out preferably using an extrusion die of particular design, for instance a T-die, a fishtail die or a coathanger die, which differ according to the design of their flow channel. Given an appropriate process regime, it is also possible to obtain an oriented adhesive layer in the coating operation.

Following the application of the adhesives, they can be subjected to post-crosslinking in order, for instance, to adjust the viscosity of the adhesive in accordance with the desired cohesion. Such post-crosslinking may be initiated by subjecting the PSA to ultraviolet light (UV crosslinking) and/or electron beams (electron-beam crosslinking).

In the case of UV crosslinking, the adhesive is exposed to irradiation with shortwave ultraviolet light, generally from a wavelength range from 200 nm to 400 nm. This is usually done using high-pressure or medium-pressure mercury lamps with an output of 80 to 240 W/cm². The particular wavelength required is dependent on the UV photoinitiator used. The intensity of irradiation is adapted to the particular quantum yield of the UV photoinitiator and to the degree of crosslinking that is to be established. In order to allow a uniform crosslinking of the adhesive it is important that the UV light is able to illuminate the adhesive completely, in particular over the entire thickness of the adhesive layer. For this reason, the inventive embodiment of the first adhesive is advantageous, according to which provision is made for the first adhesive to be not completely white but instead only translucently white.

In the case of electron-beam crosslinking, the adhesive is subjected to a beam of electrons. In this context it is possible to employ different irradiation equipment on the basis of electron-beam accelerators, examples being linear cathode systems, scanner systems or segmented cathode systems. A comprehensive depiction of the state of the art and of the most important process parameters is found in Skelhorne, “Electron Beam Processing”, in “Chemistry and Technology of UV and EB Formulations for Coatings, Inks and Paints”, vol. 1, 1991, SITA, London. Typical acceleration voltages are situated in the range from about 50 kV to 500 kV, preferably from 80 kV to 300 kV. The respective scattered dose is between 5 kGy and 150 kGy, more particularly between 20 kGy and 100 kGy. It is also possible, moreover, to carry out a combination of electron-beam crosslinking and UV crosslinking. Instead or in addition it is also possible to employ other methods which allow irradiation with high-energy radiation.

To facilitate storage and handling as a pressure-sensitive adhesive tape, the adhesives of the double-sidedly bondable sheetlike elements can be lined with one or two temporary carriers, examples being release films or release papers. These may be composed of all, arbitrary release systems and may be, for example, siliconized or fluorinated films or papers, such as those of glassine or HDPE- or LDPE-coated papers, which may additionally have an adhesion-reduced lamina (release lamina), for instance those based on silicones or fluorinated polymers.

### BRIEF DESCRIPTION OF THE DRAWINGS

Further advantages and possible applications are apparent from the working examples, which are described below in more detail with reference to the attached drawings. In the drawings

FIG. 1 shows a diagrammatic representation of a liquid-crystal display system with a double-sided adhesive tape,

FIG. 2 shows a diagrammatic representation of a cross section through a sheetlike element of the invention according to one embodiment, and

FIG. 3 shows a diagrammatic representation of a cross section through a sheetlike element of the invention, according to another embodiment.

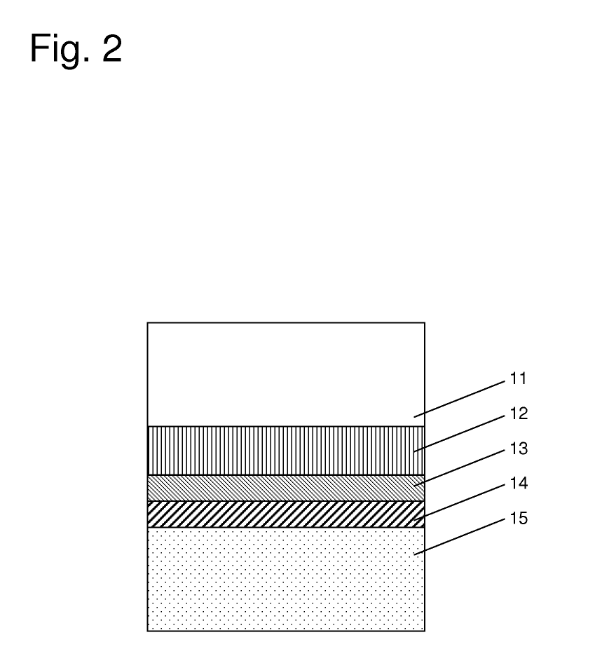

The sheetlike element as shown in FIG. 2 has a translucent white adhesive 11 as a first adhesive coating on the top face of a carrier film 12. Deposited on the bottom face of the carrier film 12 is a metallic lamina 13 as metallization layer. This layer is covered on one side with a black varnish 14 as a blacking layer. Arranged on the black varnish 14 is a transparent adhesive 15 as a second adhesive layer.

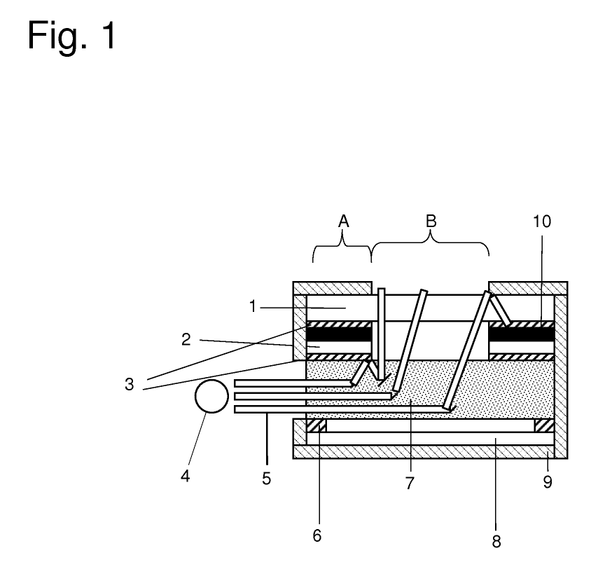

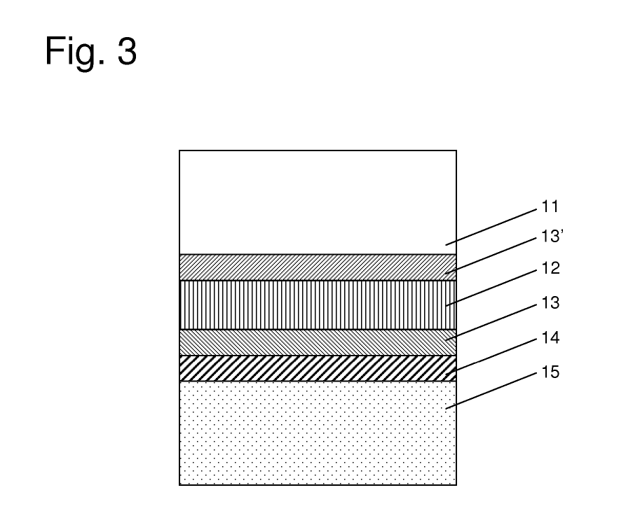

The adhesive tape shown in FIG. 3 possesses the same construction as that depicted in FIG. 2, with the difference that in this case, between the translucent white adhesive 11 and the carrier film 12, there is a further metallic lamina 13′ as a metallization layer. Deposited on the underside of the carrier film 12—as in the case of the diagrammatic construction shown in FIG. 1—is a metallic lamina 13, which is covered on one side with a black varnish 14, on which, in turn, a transparent adhesive 15 is arranged.

The invention may be illustrated further below with reference to a number of examples, selected exemplarily, without wishing for the choice of these examples to impose any unnecessary restriction.

The PSAs used were two acrylate-based adhesives which have the same base adhesives and differ merely in the admixing of the white pigment. For the preparation of the base adhesive, a 200 l reactor conventional for free-radical polymerizations was charged with 2400 g of acrylic acid, 64 kg of 2-ethylhexyl acrylate, 6.4 kg of methyl acrylate, and 53.3 kg of a mixture of acetone and isopropanol (prepared in a 95:5 ratio). Any residues of water and oxygen were removed from the reaction mixture by passing nitrogen through it, with stirring, for forty five minutes. Thereafter the reactor was heated to a temperature of 58° C., and 40 g of 2,2′-azoisobutyronitrile (AIBN) were added.

After the end of the addition, the flask was heated using a heating bath heated at 75° C., and the reaction was carried out at the temperature which resulted in the flask. After a reaction time of one hour, there was further addition of 40 g of AIBN. 5 h after the beginning of the reaction and 10 h after the beginning of the reaction, the reaction mixture was diluted with 15 kg each time of the acetone-isopropanol mixture (95:5). 6 h after the beginning of the reaction and 8 h after the beginning of the reaction, the reaction mixture was admixed with 100 g each time of dicyclohexyl peroxydicarbonate (Perkadox 16®, Akzo Nobel), dissolved beforehand in 80 g of acetone. After a total reaction time of 24 h, the reaction was terminated and the reaction mixture was cooled to room temperature.

Before the composition was applied to a carrier, the resultant adhesive was diluted with isopropanol to a solids content of 25%. Subsequently, with vigorous stirring, 0.3% by weight of aluminum(III) acetylacetonate (as a 3% strength solution in isopropanol) was added, relative to the total mass of the adhesive.

The base adhesive obtained in this way was used, without further alteration or additization, as mixture 1 for the second adhesive, or for a comparative example of a first adhesive. Further mixtures for the first adhesive were obtained from the base adhesive by admixing of white pigments. For this purpose a mixture of the base adhesive and different fractions of titanium dioxide (primarily rutile particles; average particle size: <5 μm; purity: 99.9+%) was mixed for 1 h using an intensive stirrer, and the resulting mixture was homogenized in a high-performance dispersing apparatus (Ultraturrax) for about 30 min. For mixture 2, 3% by weight of titanium dioxide was added to the base adhesive, for mixture 3, 6% by weight, for mixture 4, 10% by weight, and for mixture 5, 25% by weight, based in each case on the mass of the polyacrylate. The first adhesive thus obtained was filtered, immediately after having been homogenized, through a filter with a pore size of 50 μm, and then was coated from solution.

For crosslinking, the first adhesive and the second adhesive were coated from solution in each case onto release paper (polyethylene-coated release paper from Loparex), which had been siliconized beforehand, and were dried at 100° C. in a drying cabinet for 10 min.

In order to produce a white-colored carrier, a polyethylene terephthalate copolymer was mixed with 20% by weight of titanium dioxide particles (average particle size about 0.25 μm) in a kneading apparatus at 180° C. for 2 h and then the mixture was dried under vacuum. The resultant film material was extruded in a single-screw extruder at a temperature of 280° C. through a slot die (T-shaped, 300 μm slot gap). The resulting film was transferred to a mirror-coated chilled roll and then stretched in the longitudinal direction by heating to temperatures of 90° C. to 95° C. (stretching: approximately 3.5 times). Following longitudinal orientation, the film was introduced into a tensioning apparatus, where it was fixed using brackets and oriented at temperatures between 100° C. and 110° C. in transverse direction (stretching: approximately 4 times). Finally, the biaxially oriented film was heated at a temperature of 210° C. for 10 s and wound up onto a roll core: to prevent blocking of the film plies, a paper web (13 g/m²) was inserted between the individual film plies. The whitish PET film obtained in this way possesses an overall thickness of 38 μm.

Instead of the whitish PET film, a commercially available polyester film (SKC polyester film SC 51) was used as carrier.

The carrier film used in each case was then vapor-coated on one or both sides with aluminum until, in each case, a continuous aluminum lamina had been applied over the full area. Coating of the film with aluminum over a width of 300 mm took place in a sputtering procedure. For this purpose the film to be coated was fixed on a mount in a high-vacuum chamber, and the chamber was evacuated. When positively ionized argon gas was then passed into the high-vacuum chamber, the argon ions struck a negatively charged aluminum plate and, at the molecular level, detached clusters of aluminum, which deposited on the polyester film, guided via the plate for that purpose. The aluminum laminae obtained in this way have a high homogeneity and at the same time a high reflection capacity for light from the visible region of the spectrum.

For the blacking layer, first of all a black color varnish was prepared. It contained, for 35 parts of the main component (Daireducer™ V No. 20 from Dainippon Ink and Chemicals, Inc.), 4 parts of a curing agent (CVL No. 10 from Dainippon Ink and Chemicals, Inc.) and also 100 parts of a color pigment (Panacea™ CVL-SPR805 from Dainippon Ink and Chemicals, Inc., an ink based on vinyl chloride/vinyl acetate).

The color varnish obtained in this way was applied flatly to one of the metallized side faces of the carrier film (in this case, these side faces were vapor-coated with aluminum) and was dried at 45° C. for 48 h. The coat weight obtained in this procedure was approximately 2 g/m². The side of the sheetlike element that was coated with black varnish had a homogeneously jet-black coloration over the full area in each case.

For example 1, the whitish PET carrier film was coated on both sides with aluminum, and the black color varnish was applied to one of the two aluminum laminae. On the other of the two aluminum laminae, mixture 2 was applied as a first adhesive layer, and mixture 1 was applied to the black color varnish, as a second adhesive layer, in a laminating process. The adhesive coat weight for the first adhesive coating and for the second adhesive coating was 50 g/m².

For example 2, the commercial carrier film SC 51 was coated on one side with aluminum, and the black color varnish was applied to the aluminum lamina. Applied to the uncoated side of the carrier film was mixture 3, as a first adhesive layer, and mixture 1 as a second adhesive layer was applied to the black color varnish in a laminating process. The adhesive coat weight for the first adhesive coating and for the second adhesive coating was 20 g/m².

For example 3, the commercial carrier film SC 51 was coated on both sides with aluminum, and the black color varnish was applied to one of the two aluminum laminae. On the other of the two aluminum laminae, mixture 4 was applied as a first adhesive layer, and mixture 1 was applied to the black color varnish, as a second adhesive layer, in a laminating process. The adhesive coat weight for the first adhesive coating and for the second adhesive coating was 20 g/m².

For comparative example 1, the commercial carrier film SC 51 was coated on both sides with aluminum, and the black color varnish was applied to one of the two aluminum laminae. On the other of the two aluminum laminae, mixture 1 was applied as a first adhesive layer, and likewise mixture 1 was applied to the black color varnish, as a second adhesive layer, in a laminating process. The adhesive coat weight for the first adhesive coating and for the second adhesive coating was 50 g/m².

For comparative example 2, the whitish PET carrier film was coated on one side with aluminum, and the black color varnish was applied to the aluminum lamina. Applied to the uncoated side of the carrier film was mixture 5, as a first adhesive layer, and mixture 1 as a second adhesive layer was applied to the black color varnish in a laminating process. The adhesive coat weight for the first adhesive coating and for the second adhesive coating was 50 g/m².

The five different sheetlike elements obtained in this way were investigated for their optical properties.

For the measurement of the transmittance, a UV/Vis/NIR absorption spectrometer (Uvikon 923 from Biotek Kontron) was used to measure transmission spectra in the wavelength range from 190 nm to 900 nm. The value used for comparison was the absolute transmission at 550 nm (specified as a percentage of the irradiated light).

For the determination of the optical defects (pinholes), a strong light source was needed. Therefore, the light arrow of an overhead projector (Liesegangtrainer 400 KC model 649 with 36 V/400 W halogen lamp) was given a fully lightfast masking, with a mask, except for a circular sample aperture in the middle of the light arrow, with a diameter of 5 cm. The sample under analysis was placed onto this opening, and the defects were detected and counted as light spots in a darkened environment. Detection and counting were able to take place visually or electronically.

Furthermore, the reflection of the samples was determined in accordance with DIN standard 5063 part 3, using an Ulbricht sphere (type LMT). For each sample investigated, both the reflectance, i.e., the total measured reflection as sum of directed and scattered light fractions, and also the scattered and diffuse light fractions separately, were recorded (in each case as percentages).

The results of the investigations are reproduced in table 1 below.

TABLE 1

| | | | | Reflection |
|---|---|---|---|---|
| | | Number of | Reflection | (scattered/ |
| Sample | Transmittance | holes | (total) | diffuse |
| Example 1 | <0.1% | 0 | 83.4% | 36.1% |
| Example 2 | <0.1% | 0 | 81.7% | 42.4% |
| Example 3 | <0.1% | 0 | 80.2% | 49.3% |
| Comparative | <0.1% | 0 | 86.6% | 24.8% |
| example 1 | | | | |
| Comparative | <0.1% | 0 | 76.9% | 68.1% |
| example 2 | | | | |

The experiments show that none of the systems investigated had optical defects. At the same time, all of the systems possessed very low transmission in the visible region. Differences came about, however, in the case of the reflection values: thus it can be seen that, when using an exclusively metallically reflecting side face of the sheetlike element, the reflection obtained overall was very high. For comparative example 1, with no colored adhesive, however, the fractions of scattered light were very small. In the case of this conventional system, therefore, there may be inhomogeneous lighting of the display field. When using an exclusively white side face of the sheetlike element, the reflection obtained overall was indeed lower than in the case of the other systems, but the diffusively scattered fractions were relatively large (comparative example 2). Example 1, 2, and 3, on the other hand, demonstrate that with the sheetlike element of the invention it was possible overall to obtain a high reflection of more than 80%, with the scattered fraction likewise being relatively high (between 30% and 50%).

Supplementary experiments showed, furthermore, that with a scattered-light fraction of less than 30%, the lighting of the display field can be poor, and so there may be inhomogeneities in the form of spotlike light images (light spots), whereas, with a scattered-light fraction of more than 50%, perceptible color distortions may occur. These two effects can be avoided by using the sheetlike element of the invention.

What is claimed is:

1. A pressure-sensitively adhesive sheetlike element for producing liquid-crystal display systems, the sheetlike element comprising the following sequence of layers: first adhesive layer, carrier, metallization layer, blacking layer, second adhesive coating, the blacking layer being a layer comprising a black color varnish and/or primer which is not pressure-sensitively adhesive at room temperature,
wherein
the first adhesive layer has, over its entire thickness, white pigments at a mass fraction in a range of at least 2% by weight and not more than 10% by weight.

2. The sheetlike element of claim 1, wherein the blacking layer comprises carbon-black particles and/or graphite particles in a cured polymer matrix.

3. The sheetlike element of claim 2, wherein the carbon-black particles and/or graphite particles in the polymer matrix are present at a mass fraction of more than 20% by weight.

4. The sheetlike element of claims 1, wherein the blacking layer has a transmittance in the wavelength range from 300 nm to 800 nm of less than 0.5%.

5. The sheetlike element of claim 1, wherein the carrier top face in contact with the metallization layer has an antiblocking agent content of less than 4000 ppm.

6. The sheetlike element of claim 1, wherein the carrier is a PET film.

7. The sheetlike element of claim 6, wherein the PET film top face in contact with the metallization layer exhibits structuring with elevations of not more than 400 nm in height.

8. The sheetlike element of claim 1, wherein the metallization layer comprises a metallic-varnish lamina and/or a metallic lamina of aluminum or silver.

9. A method for producing and/or adhesively bonding liquid-crystal display systems, said method comprising bonding liquid-crystal display elements with the sheetlike element of claim 1, the second adhesive thereof being bonded with a surface of a liquid-crystal display element.

10. A liquid-crystal display system comprising a liquid-crystal display element, a protective element, and a frame element, at least two of these elements being joined with a sheetlike element of claim 1.
